(19) United States
(12) Patent Application Publication
(10) Pub. No.: US 2017/0221350 A1
(43) Pub. Date: Aug. 3, 2017

(54) OPERATING UNIT AND CONTROL SYSTEM FOR AN ELECTROMOTIVE ADJUSTING DRIVE OF A PIECE OF FURNITURE

(71) Applicant: DEWERTOKIN GMBH, Kirchlengern (DE)

(72) Inventor: Armin HILLE, Bielefeld (DE)

(73) Assignee: DewertOkin GmbH, Kirchlengern (DE)

(21) Appl. No.: 15/500,787

(22) PCT Filed: Jul. 28, 2015
(86) PCT No.: PCT/EP2015/067280

§ 371 Date: Jan. 31, 2017

(30) Foreign Application Priority Data
Aug. 1, 2014 (DE) 10 2014 110 956.2

(51) Int. Cl. G08C 17/00; A47C 31/00; A47C 20/04; H01Q 7/08; H04B 5/00

(52) U.S. Cl. CPC G08C 17/00; H01Q 7/08; H04B 5/0075; A47C 20/041; A47C 31/008; G08C 2201/10

(57) ABSTRACT

The invention relates to an operating unit (10) for at least one electromotive adjusting drive (7, 8) of a piece of furniture (1), having:—at least one operating element (12, 13),—a transmission unit (16) for wirelessly transmitting signals on the basis of actuation of the at least one operating element (12), and—a rechargeable energy store (17) for storing electrical energy for supplying power to the operating unit (10). The invention is distinguished by the fact that it has a device (20) for inductively receiving energy for charging the energy store (17). The invention also relates to a control system for controlling at least one adjusting drive of a piece of furniture, and to a piece of furniture having such a control system.

The invention relates to an operating unit for an electromotive adjusting drive of a piece of furniture having at least one operating element and a transmission unit for wireless transmission of signals depending on an actuation of the at least one operating element. The invention furthermore relates to a control system for controlling at least one adjusting drive of a piece of furniture, which has a control device connected to the at least one adjusting drive and such an operating unit. Furthermore, the invention relates to an item of furniture having a base element and a support element, which is movably guided via at least one adjusting drive in the base element, which has such a control system.

Adjusting drives, frequently also referred to as electromotive furniture drives, are installed in reclining and sitting furniture to be able to conveniently move an adjustment of furniture parts such as seats, backrest, foot rests, etc. in relation to a base body of the furniture and in relation to one another. Adjustable sitting furniture, in particular so-called television or relaxation chairs, typically have for this purpose a furniture fitting, which is relatively mechanically complex and which, in the interaction of a plurality of levers and linkages, enables a complex movement sequence of the various cushion units mounted thereon. In the case of beds or other reclining furniture, a frame is typically provided as the base element, which supports a slatted frame having movable head and foot parts.

For the control and power supply of the adjusting drives, a control device is arranged on or in the piece of furniture, which receives operating commands of a user from an operating unit and converts them into control signals for the adjusting drives.

To enable convenient operation of the control unit, which is also not hazardous with regard to a possible risk of tripping, and therefore of the adjusting drives, wireless operating units are known, which have at least one operating element and a transmission unit for the wireless transmission of signals depending on an actuation of the at least one operating element. Such a wireless operating unit, frequently also referred to as a remote control, can use radio signals, light, in particular infrared light, or also ultrasound for transmitting the signals in this case.

Such a wireless operating unit has the disadvantage that it has to have an energy accumulator for storing electrical energy to power the operating unit. A battery to be used once (disposable battery) or a rechargeable battery (accumulator cell) is frequently used for this purpose as the energy accumulator. In both cases, it is disadvantageous that empty batteries have to be removed and have to be replaced with new or recharged batteries. Disposable batteries are additionally disadvantageous for ecological reasons.

It is therefore an object of the present invention to specify an operating unit and a control system and an item of furniture having such a control system, in which complex replacement of the energy accumulator after emptying is omitted.

This object is achieved by an operating element, a control system, and an item of furniture having the respective features of the independent claims. Advantageous embodiments and refinements are specified in the respective dependent claims.

An operating unit according to the invention of the type mentioned at the outset is distinguished in that it has a device for inductively receiving energy for charging the energy accumulator. By way of the device for receiving inductively transmitted energy, an empty energy accumulator can be recharged, without the energy accumulator having to be removed and/or without a cable connection having to be temporarily established. The charging of the energy accumulator can be performed conveniently in this manner, without an action of a user especially for this purpose being necessary. This is true in particular if the energy transmission for charging the energy accumulator takes place when the operating unit is located at a place at which it is typically stored. In this manner, it is ensured that the energy accumulator is always full and the operating unit is ready for use at all times.

In one advantageous embodiment of the operating unit, the device for receiving the inductively transmitted energy has an inductor and an AC/DC converter (alternating current/direct current converter) connected thereto. The inductor, for example, a coil, is used to receive the inductively transmitted energy. It provides an AC voltage at its terminals, which is converted by the AC/DC converter into a DC voltage suitable for charging the energy accumulator. The inductor is preferably formed as a coil having ferrite core, which is arranged inside a housing of the operating unit, adjacent to a wall of the housing. Energy may be transmitted with low transmission losses using coils having ferrite core, wherein a high efficiency of the energy transmission is achieved. This can be further optimized if the coil having the ferrite core is arranged as close as possible to a housing wall.

In a further advantageous embodiment of the operating unit, the energy accumulator is a rechargeable battery and/or a high-capacitance capacitor. A rechargeable battery is distinguished by a high storage capacity in relation to its size and its weight. Alternatively and/or additionally, the high-capacitance capacitor, for example, a so-called double-layer capacitor, can be used, which is distinguished by a small structural size and the possibility of rapid charging. A rechargeable battery and a high-capacitance capacitor can optionally also be used jointly, whereby both advantages, the high storage capacity and the rapid charging of at least a part of the available storage capacity, may be achieved simultaneously. The mentioned AC/DC converter is preferably connected to a charging circuit for the energy accumulator. The charging circuit is preferably adapted in this case to the type of the energy accumulator.

In a further advantageous embodiment, the energy accumulator is arranged replaceably in the operating unit. A replacement is typically performed by partially opening the housing of the operating unit to be able to replace a rechargeable battery and/or a high-capacitance capacitor. Alternatively, the entire housing can be opened. A high-capacitance capacitor is fundamentally considered to be maintenance free. However, the operating unit is designed as a very long-lived product, the service life of which can exceed that of rechargeable batteries, but also that of a high-capacitance capacitor. Replaceability of the energy accumulator thus offers the possibility of exhausting the service life of the operating unit.

In a further advantageous embodiment of the operating unit, terminals such as plug terminals or clamp terminals are provided, which can be connected to the terminals of the high-capacitance capacitor or the rechargeable battery.

In a particularly advantageous embodiment of the operating unit, a high-capacitance capacitor is used as the energy accumulator, which is provided with a housing, which corresponds to the construction of the commercially-available rechargeable battery. Such housings correspond, for example, to the size designation for batteries and cells according to the ANSI code AA, AAA, N, 9 V, 1811A. Alternatively, such housings are also known under the designation mini, micro, lady, 4AG13, L1325, 23A, duplex.

In a further advantageous embodiment, the operating unit has touch-sensitive and alternatively proximity-sensitive actuating regions on the operating side. The touch-sensitive or proximity-sensitive actuating regions can be manually actuated as a replacement for the buttons or alternatively as a supplement to the buttons. The actuating regions are operationally connected to a corresponding sensor system and a switching unit, wherein the respective switching command to control a motorized movable furniture component is triggered by touching or alternatively by proximity.

In a further advantageous embodiment of the operating unit, the device for receiving inductively transmitted energy has a data transmission unit for inductively transmitting data. An AC voltage signal is used for the inductive transmission, which can be low frequency and which can be, for example, one of the network frequencies of, for example, 50 Hz or which can be in a higher frequency range, preferably in a range of several tens of kilohertz or several hundred kilohertz. Data can be modulated onto the signal using which energy is transmitted, for example, in an amplitude, frequency, or phase modulation method. Data modulated onto the signal for transmitting the energy can be received by the operating unit and demodulated by the data transmission unit, which then has a corresponding demodulator, and provided at a data output for further use. For example, it is conceivable that programming of the operating unit is performed via the data transmission unit, using which, for example, for a specific module of an electromotive adjusting drive to be controlled or a control device of such an adjusting drive, a specific functional movement of the operating elements, also called button assignment, is transmitted. Programming of the operating unit is then possible, even if the operating unit is unidirectional in its wireless transmission channel for transmitting the signals of the operating elements and is only designed as a transmitter.

The data transmission unit can provide one or more data transmission links. If multiple data transmission links are available, a first transmission link can be designed and provided to transmit the energy, while a further transmission link is designed and provided to transmit data for information exchange and for control of movement processes of the item of furniture. The transmission links can be formed and arranged independently of one another (autonomously). Alternatively, they can use a shared transmission channel in combination with one another, which the various transmission links occupy in chronological succession or alternately. The transmission of energy and the transmission of data and control commands can thus be performed in succession, alternatively alternately in succession, in a so-called time multiplexing method. Therefore, interference in the case of data transmission during simultaneous energy transmission can be precluded.

It is also possible to design the data transmission unit so that it can also be used to transmit data from the operating unit to another unit. For this purpose, for example, the inductive transmission of the energy to the operating unit can be interrupted, to transmit a signal having modulated data from the operating unit to the further unit. The data transmission unit can preferably be connected for this purpose to a charge state monitor to monitor a charge state of the energy accumulator. In this embodiment, a charge state of the energy accumulator can be communicated from the operating unit to the energy transmission unit, to signal a need for inductive transmission of energy.

A control system according to the invention of the type mentioned at the outset is distinguished by such an operating unit, wherein the system furthermore comprises an energy transmission unit for inductively transmitting electrical energy to the operating unit. The above-explained advantages result in conjunction with the operating unit.

In one advantageous embodiment of the control system, the energy transmission unit is connected to the control unit and/or is integrated into the control unit for its power supply. In this manner, a compact construction of the control system may be achieved and the energy transmission unit may be implemented without great additional apparatus expenditure.

In one alternative, however, it is also possible to supply the energy transmission unit with power by way of a power supply unit separate from the control device. In one embodiment, the power supply takes place from the network. In such an embodiment, it can be provided that the control device is coupled to a network cutoff device or this network cutoff device is integrated into the control device, wherein the network cutoff device is coupled to the energy transmission unit such that a network cutoff takes place when the operating unit interacts with the energy transmission unit.

Pieces of furniture having adjusting drives frequently have a so-called network cutoff unit, which disconnects the control device when the adjusting drives are not actuated. The cutoff can be performed, for example, by a controlled relay or semiconductor switch having at least one switch contact and preferably two switch contacts, by which a network-side input voltage is interrupted at all poles if necessary. If such a network cutoff unit is integrated into the control device or connected upstream thereof, the network cutoff takes place in the idle state of the adjusting drive and has to be canceled to actuate the adjusting drive. In the mentioned embodiment, the network cutoff is turned on and off by the energy transmission unit. In this case, a network cutoff takes place when the operating unit interacts with the energy transmission unit, wherein it is presumed that such an interaction only takes place when the operating unit is not used, but rather is located in a “parking position”. An interaction can be, for example, that the energy transmission unit inductively transmits energy to the operating unit. A storage option for the operating unit can be provided, for example, integrated in the piece of furniture or arranged in the region of the piece of furniture, for example, a storage table or a storage shelf. If the operating unit is not used, it is placed in this storage option, in the vicinity of which the energy transmission unit is also arranged, which then transmits energy to the operating unit to charge the energy accumulator in the idle state. If the operating unit is removed from the storage option, this thus typically takes place for the purpose of operating the electromotive adjusting drive. The inductive transmission of energy by the energy transmission unit is interrupted by the removal of the operating unit, because such an inductive transmission can typically only be performed in the near field. The removal of the operating unit can thus be detected on the basis of the coupling during the inductive energy transmission from the energy transmission unit and can be used for the network cutoff. The removal then turns on the network-side input voltage, wherein, for example, a controlled relay switch or semiconductor switch is provided, which switches energy from the network to the control device.

In a further advantageous embodiment of the control system, the energy transmission unit has a data transmission unit for inductively transmitting data. The energy transmission unit can preferably be configured to set a maximum transmitted power depending on items of information which the data transmission unit receives. The items of information particularly preferably relate to a charge state of the energy accumulator of the operating unit. As already explained in conjunction with the operating unit, in this manner, a needs-based control of the energy provided by the energy transmission unit to the operating unit can be performed.

A piece of furniture according to the invention of the type mentioned at the outset comprises such a control system. The energy transmission unit is preferably entirely or partially integrated into the piece of furniture in this case. Furthermore, the energy transmission unit preferably has a storage option for the operating unit, which has an inductor and/or in which an inductor is integrated. Via the inductor, in particular a coil, a transmission of the energy to the operating unit can be performed when it is located in the storage option. By integrating the storage option into the item of furniture, misplacing the operating unit is prevented. If it is then stored at the storage space assigned thereto when it is not required, it is ensured that its energy accumulator is charged at all times.

The invention will be explained hereafter on the basis of exemplary embodiments with the aid of figures.

In the figures:

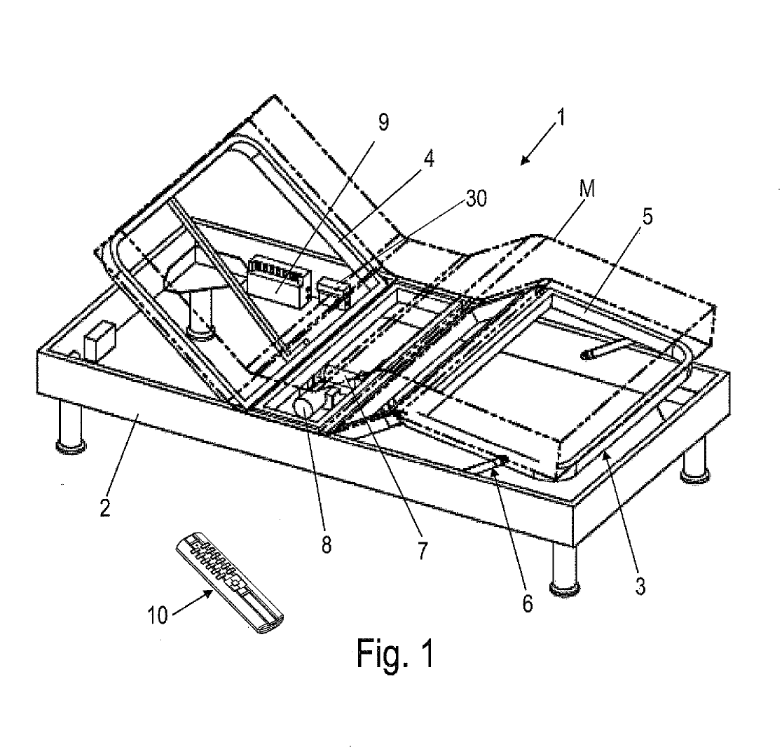

FIG. 1 shows a schematic perspective view of an exemplary furniture arrangement;

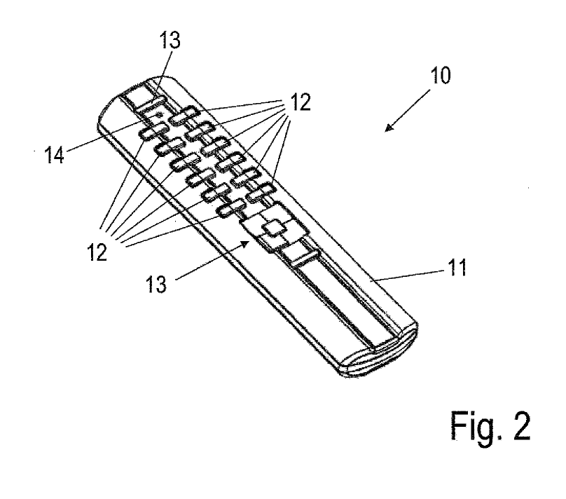

FIG. 2 shows a schematic perspective view of an operating unit;

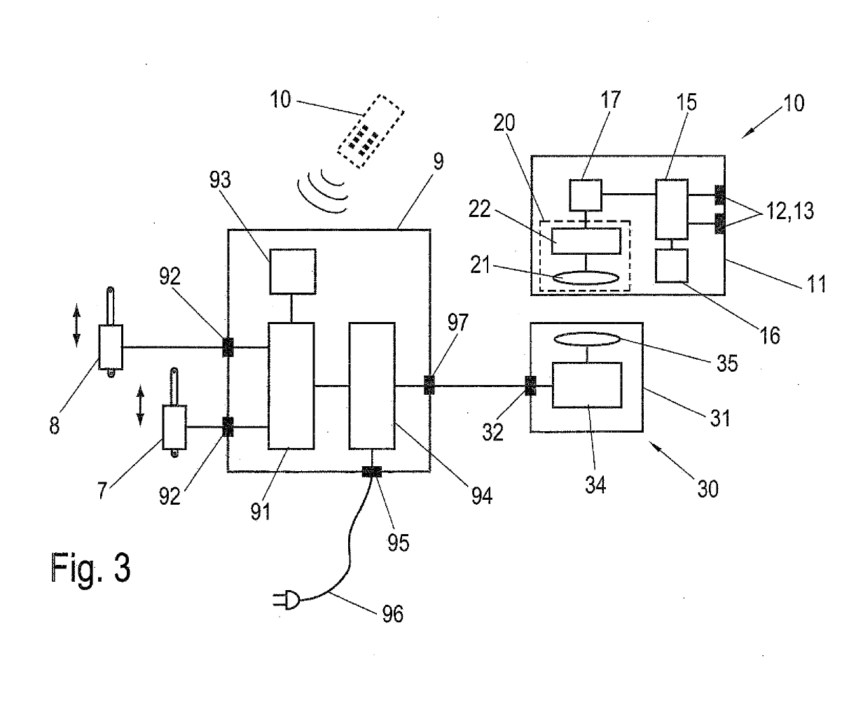

FIG. 3 shows a block diagram of a control system for adjusting drives having an operating unit in a first exemplary embodiment;

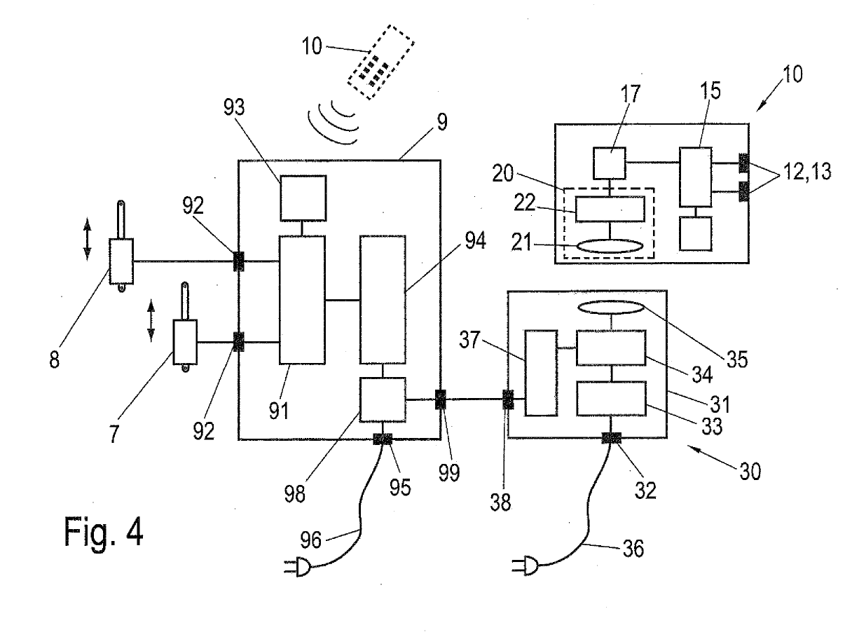

FIG. 4 shows a block diagram of a control system for adjusting drives having an operating unit in a second exemplary embodiment; and

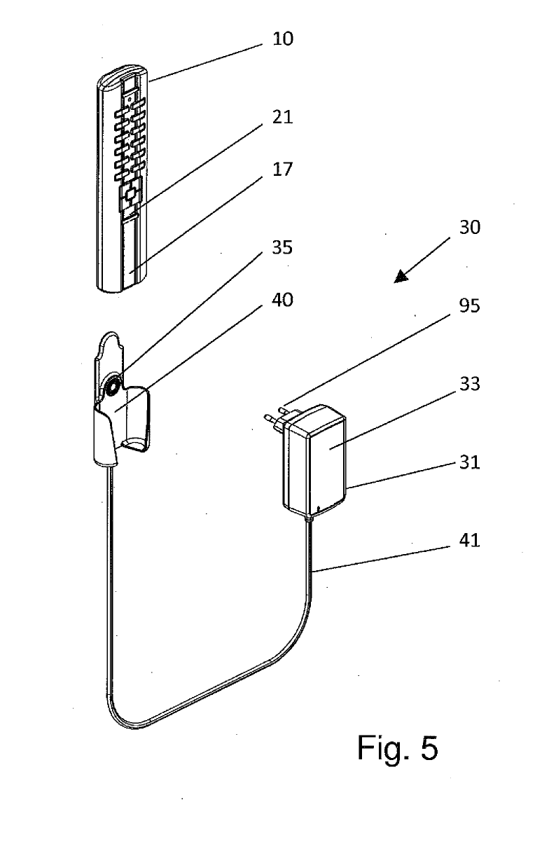

FIG. 5 shows a storage table for storing an operating unit.

FIG. 1 shows a furniture arrangement having a piece of furniture 1. A bed is shown here by way of example as the piece of furniture 1. The piece of furniture 1 has at least one support element 3 for accommodating objects, a cushion, a mattress M, and/or a person. The support element 3 is designed, for example, as a slatted frame, as a level support surface, or the like and is placed on a base element 2, a framework having feet here, using which the piece of furniture 1 is set up at a setup location, for example, a floor.

The support element 3 has a back part 4 and a leg part 5 here, which are arranged movably mounted in relation to a further support element or in relation to the base element 2. This movable arrangement is implemented here by means of a so-called movement fitting 6. The movement is designed as displaceable and/or pivotable.

The movably mounted back part 4 and the leg part 5 are each coupled to an electromotive adjusting drive 7, 8. The back part 4 is thus coupled to the electromotive adjusting drive 7. The electromotive adjusting drive 8 is provided for moving or adjusting the leg part 5.

The electromotive adjusting drives 7, 8 are designed here as linear drives. The linear drives have one or multiple electric motors, wherein a speed-reducing gear having at least one gear step is connected downstream of each motor. A further gear, for example, in the form of a threaded spindle drive, which generates a linear movement of an output element from the rotational movement of the motor, can be connected downstream from the speed-reducing gear. The last gear element or a further element connected thereto forms the output element. The output element of the respective electromotive adjusting drive is connected to the respective furniture component (back part 4, leg part 5) or alternatively to a component connected to the base element 2, so that in the event of an operation of the electric motor of the respective adjusting drive 7, 8, the movable furniture components 4, 5 are adjusted in relation to one another or in relation to the base element 2.

The electromotive adjusting drives 7, 8 are connected to a control device 9. This connection can be embodied, for example, as a pluggable cable connection, which is not shown in greater detail here. The control device 9 has an electrical supply unit, which provides the electrical energy, for example, from the network, for the electromotive adjusting drives 7, 8. For this purpose, the control device 9 is connectable via a network cable (not shown in this example) to a network plug having a network terminal. The network plug conducts, via the network cable, the input-side network voltage to the electrical supply unit of the control device 9, which outputs a low voltage in the form of a DC voltage on the secondary side and relays it to a motor controller.

Alternatively thereto, a network-dependent voltage supply (not shown in greater detail) having network input and having secondary-side low voltage output, which supplies the low voltage in the form of a DC voltage via the line, is connected upstream from the control device 9.

Furthermore, an operating unit 10 is associated with the piece of furniture 1 or the control device 9. FIG. 2 shows such an operating unit 10 in an exemplary embodiment in a schematic perspective view. The operating unit 10 has operating elements 12, 13, by means of which the electromechanical adjusting drives 7, 8 are controllable via the control device. The operating unit 10 is provided with a transmission device for wireless transmission of signals. The wireless transmission can be implemented by a wireless transmission link, an optical transmission link (for example, for infrared light), and/or an ultrasound transmission link, wherein the control device 9 is equipped with a respective corresponding receiving unit.

The operating elements 12 are embodied in the present case as buttons. For example, the operating elements 12 arranged on one side of the operating unit 10 are used for raising and the operating elements 12 arranged on the other side of the operating element 10 are used for lowering the respective movable furniture part. The operating unit 10 shown by way of example thus has operating capability for six adjusting drives. In addition, further operating elements 13 are provided as auxiliary operating elements, via which auxiliary functions can be operable. The auxiliary operating elements can be embodied as buttons and/or switches. Furthermore, the operating unit 10 is equipped with a signaling element 14, for example, a light-emitting diode or a display unit. The signaling element 14 is used, for example, for functional display or feedback, error display, etc.

Upon actuation of an operating element 12, 13, a control signal for controlling the respective electromechanical adjusting drive 7, 8 is transmitted via the transmission link in a wireless or wired manner to the control device 9. The control device has switch elements, which convert the control signals of the transmission link into switch signals for switching the respective adjusting drive 7, 8. The switching elements can be, for example, relay switches and/or semiconductor switches. The manually actuable operating elements 12, 13 of the operating unit 10 generate control signals, which are converted by the receiver of the control device 9 into control currents for the switch elements.

Furthermore, an energy transmission unit 30 is connected to the control device 9, which is arranged in the present example of FIG. 1 on an inner side of the base element 2. On the outer side of the base element 2 in the region of the energy transmission unit 30, a storage pocket (not visible in FIG. 1) for the operating unit 10 is located, into which the operating unit 10 can be inserted when it is not required. When the operating unit 10 is inserted into this storage pocket, it is located in the near field of the energy transmission unit 30, which transmits energy inductively to the operating unit 10, to charge the energy accumulator thereof. An exemplary embodiment of a suitable storage pocket will be explained in greater detail hereafter in conjunction with FIG. 5.

FIG. 3 shows the control system of an item of furniture having electromotive adjusting drives in greater detail in the form of a schematic block diagram. The arrangement shown in FIG. 3 can be provided, for example, in the item of furniture 1 of FIG. 1.

The control device 9 has a control unit 91, which is connected via adjusting drive terminals 92 to adjusting drives 7, 8. Electric motors arranged in the adjusting drives 7, 8 are indirectly or directly controlled and/or supplied with current via the adjusting drive terminals 92. In addition, a signal of an end switch arranged in the respective adjusting drive 7, 8 can be transmitted to the control device 9 via the adjusting drive terminals 92. However, analyzing the end switch signal in the respective adjusting drives 7, 8 can also be provided. Furthermore, signal lines can be provided, via which a position of an output element of the adjusting drive 7, 8 is transmitted to the control device 9, to consider this position signal in the control of the adjusting drives 7, 8.

Furthermore, the control unit 9 has a receiving unit 93 for receiving the signals of the operating unit 10. Signals which are transmitted by the operating unit 10 and relate to the actuation of the operating elements 12, 13 are converted by the control device 9 into signals for the adjusting drives 7, 8. For this purpose, switch elements, for example, relays or semiconductor power switches, are provided in the control unit 91, which switch a motor current for the electric motors in the adjusting drives 7, 8. The receiving unit 93 is adapted to the operating unit to receive the signals of the operating unit 10, and thus accordingly has a receiver for radio signals or optical or acoustic signals. It is to be noted that the transmission between the operating unit 10 and the control device 9 can also be designed as bidirectional, to also be able to transmit signals or items of information from the control device 9 to the operating unit 10. In this case, the receiving unit 93 is accordingly designed as a transmitting and receiving unit.

For the power supply, a power supply unit 94 is provided in the control device 9, which is connected via a network terminal 95 to a network cable 96. It is apparent that the power supply unit 94 can also be arranged externally to the control device 9 and is then connected via a low-voltage terminal to the control device 9.

The operating unit 10 is shown twice in FIG. 3—on the one hand, in the form of a block diagram in a position adjacent to an energy transmission unit 30 and, on the other hand, in an optional actuation position, in which it is shown by dashed lines. In the actuation position, the emission of the signals, for example, radio signals, in the direction of the receiving unit 93 is symbolized. In the position in which the operating unit is illustrated as a block diagram, the operating unit 10 is located in a charging situation adjacent to the energy transmission unit 30.

The operating unit 10 has a housing 11, on the upper side of which, for example, operating elements 12, 13 are arranged here. The operating unit 10 furthermore comprises a control unit 15, which is connected to the operating elements 12, 13 and queries the actuation status thereof. Depending on this actuation state of the operating elements 12, 13, the control unit 15 generates signals which are emitted via a transmission unit 16 as radio signals or optical signals or acoustic signals. For the energy supply, an electrical energy accumulator 17 is arranged in the operating unit 10, which can be a rechargeable battery or a high-capacitance capacitor or a combination of the two.

In a way not shown here in greater detail, the operating unit 10 has a device for receiving a replaceable electrical energy accumulator 17. Such receptacle devices are externally accessible compartments which are covered by a closure cover. Alternatively, a housing shell or a housing part of the housing 11 of the operating unit 10 can be removed to ensure the accessibility of the receptacle device. The receptacle device comprises plug contacts for electrically connecting the electrical energy accumulator 17 to the electronic components of the operating unit 10. As noted in greater detail at the outset, in one embodiment, a replaceable high-capacitance capacitor is advantageous as the electrical energy accumulator 17.

Furthermore, the operating unit 10 comprises a device 20 for receiving inductively transmitted energy. It has an inductor 21, also referred to as a receiving coil 21 hereafter, which is coupled to an AC/DC converter 22. In the simplest case, this AC/DC converter 22 can be a rectifier having a smoothing capacitor. In more complex embodiments, the AC/DC converter 22 optionally comprises elements for voltage stabilization and/or for step-up conversion or step-down conversion of the voltage.

The output of the AC/DC converter 22 is directly or indirectly connected via a charging circuit (not shown here) to the energy accumulator 17 for the charging thereof. In this case, the charging circuit can advantageously have a recognition device (not shown in greater detail) for determining at least some charging parameters such as charging voltage, charging power, or accumulator cell type. The recognized parameters are used in the charging circuit to specify settings for the charging procedure. Such settings relate to, for example, a charging current, a charging time, and a charging mode. The latter establishes, for example, whether charging is performed using continuous or pulsed charging current.

For inductive transmission of energy, an energy transmission unit 30 is provided, which is supplied with power in the present example via the power supply unit 94 of the control device 9. For this purpose, a low-voltage terminal 97 is arranged on the control device 9, which is connected via a cable to a power supply terminal 32 of the energy transmission unit 30. In a housing 31, the energy transmission unit 30 has a DC/AC converter 34, which converts a DC voltage supplied via the power supply terminal 32 into an AC voltage, which is supplied to an inductor 35, also referred to as a transmitting coil 35 hereafter. The frequency of the AC voltage, using which the transmitting coil 35 is operated, is preferably in a range of several tens of kilohertz up to several hundred kilohertz. In this frequency range, a sufficiently high power can be transmitted to charge the energy accumulator 17 even with small geometrical dimensions of the transmitting coil 35 and/or the receiving coil 21. In alternative embodiments, however, the use of an AC voltage having lower frequency, for example, having network frequency is also possible.

In the near field of the transmitting coil 35, which extends several millimeters up to at most several centimeters viewed from the transmitting coil 35, a magnetic field which alternates with the frequency of the AC voltage is generated by the transmitting coil 35. When the operating unit 10 is located in the region of the energy transmission device 30, this magnetic alternating field penetrates the receiving coil 21, in which a voltage is thereupon induced, which results in a current flow and therefore in the transmission of energy from the energy transmission device 30 to the operating unit 10. The DC/AC converter 34 of the energy transmission unit 30 can be provided in this case with a safety circuit, which prevents a transmission of energy when electrical parameters of the transmitting coil 35 leave a predefined parameter range. For example, it can be detected in this manner when a metallic material which induces a magnetic short-circuit is located in the region of the transmitting coil 35. Preferably, the transmitting coil 35 is operated in an oscillating circuit together with a capacitor in a resonant situation at a resonant frequency. The level of the resonant frequency is a measure in this case of the (magnetic) surroundings of the transmitting coil 35. It can be established on the basis of the resonant frequency, for example, whether the receiving coil 21 is located in the region of effect of the transmitting coil 35 or whether a metallic object induces a magnetic short-circuit.

To enable an effective transmission of the energy, both the transmitting coil 35 and also the receiving coil 21 can be equipped with a ferrite core. A geometrically suitable coil design is that of a ring coil having a cup core as a ferrite core. It is obvious that other coils, for example, planar coils, can also be used, however.

Various standards have become established in the field of multimedia devices for the inductive transmission of energy, for example, the Qi standard, the Powermat standard, or the Rezence standard. The energy transmission unit 30 and/or the device 20 for receiving inductively transmitted energy can be designed according to one of the standards.

In a refinement of the exemplary embodiment shown in FIG. 3, it can be provided that the inductors 21, 35 are used not only for transmitting energy, but rather also data. For this purpose, modulators or demodulators can be integrated into the AC/DC converter 22 and into the DC/AC converter 34, which change a transmission of the AC voltage signal by means of an amplitude, frequency, or phase modulation and thus apply data to this signal. On the respective other side of the inductive transmission link, these data are extracted from the transmitted AC voltage signal again by demodulation. Although the energy transmission is formed unidirectionally from the energy transmission unit 30 to the operating unit 10, the data transmission can occur bidirectionally. A transmission of data from the operating unit 10 to the energy transmission unit 30 then takes place in pauses of the energy transmission.

With the aid of a data transmission, for example, items of information can be transmitted about a charge state of the energy accumulator 17 from the operating unit 10 to the data transmission unit 30, which thereupon sets the maximum power transmitted thereby via the inductive energy transmission link. In this manner, a control of the charging procedure can already be performed on the primary side, i.e., on the side of the energy transmission unit 30 as the transmitter of the energy used for charging the energy accumulator 17.

FIG. 4 shows a second exemplary embodiment of a control system, also in a block diagram. Identical reference signs identify identical or identically acting elements in this figure as in the preceding figure. With regard to the fundamental functionality of the control device 9, the operating unit 10, and the energy transmission unit 30, the exemplary embodiment of FIG. 4 corresponds to the exemplary embodiment of FIG. 3, to which reference is hereby made.

In contrast to the exemplary embodiment of FIG. 3, in the present case a network cutoff device 98 is connected upstream from the power supply unit 94 in the control device 9. The network cutoff device 98 interrupts the network voltage supplied to the power supply unit 94 depending on a signal supplied at a control terminal 99. In this manner, a higher level of operational reliability is achieved in a rest state of the control device 9 and the electromotive adjusting drives 7, 8. It is obvious that the network cutoff device 98 can also be arranged separately, for example, in a plug housing at the network-side end of the network cable 96.

A further difference of the exemplary embodiments is that in the example of FIG. 4, the energy transmission unit 30 has a separate power supply unit 36, wherein network voltage is supplied through a network cable 36 via the power supply terminal 32. The energy transmission unit 30 can therefore be operated autonomously and independently from the control device 9. Furthermore, a control apparatus 37 is provided in the energy transmission unit 30, which controls the function of the AC/DC converter 34 and monitors it, for example, on the basis of the resulting resonant frequency. If the operating unit 10 is located in the charging position shown and the transmitting coil 35 interacts with the receiving coil 21, the electrical properties of the transmitting coil 35 thus change in relation to a situation in which the operating unit 10 is not positioned in the region of effect of the energy transmission unit 30. This change is detected by the control apparatus 38, which therefore establishes without further elements such as switches or light barriers whether the operating unit 10 is located in the charging position, for example, in a special storage option provided for this purpose (storage pocket, storage shelf). A control output 38 of the control apparatus 37 is connected to the control input 99 of the network cutoff device 98. The network cutoff device 98 is then put into the operating mode “cut off” via the control output 38 when the operating unit 10 is in the charging position. In contrast, if the operating unit 10 is taken from the storage option and therefore removed from the charging position, the network cutoff device 98 is signaled to leave the cutoff mode and switch to an operating mode of the control device 9, in which network voltage is applied to the power supply unit 94. The control system is then ready to receive signals of the operating unit 10 to adjust the adjusting drives 7, 8.

Furthermore, in one embodiment the transmitting coil 35 and/or alternatively the receiving coil 21 can be provided with a shield. The shield has the special property of bundling the electromagnetic waves used for the transmission to reduce the power loss during the charging procedure. A further property of a shield is the reduction of electromagnetic waves exclusively to a small local region of the respective inductor 21, 35, to reduce interference with other devices and increase the EMC compatibility. Planar and three-dimensionally molded metal components are used as the materials and structural forms of such shields, wherein a ferrite-type or steel-type material is used, which conducts electromagnetic waves particularly well.

FIG. 5 shows an example of a storage pocket 40 for storing an operating unit 10, to which reference was already made in conjunction with FIG. 2. The storage pocket 40 is designed to accommodate the operating unit 10.

FIG. 5 furthermore shows an energy transmission unit 30, which is coupled to the storage pocket 40, having a power supply unit 33. The power supply unit 33 is provided with a network terminal 95 and is designed according to the figure for introduction into a socket as a so-called plugged power supply unit. The power supply unit 33 is furthermore connected via a line 41 to the storage pocket 40. Alternatively, the power supply unit 33 and the storage pocket 40 form a structural unit.

The energy transmission unit 30 has an inductor 35. According to the exemplary embodiment, the inductor 35 is integrated into the storage pocket 40. In an alternative embodiment, the inductor 35 can also be fastened in a removable and/or upgradable manner on the storage pocket 40, for example, inserted into an insertion pocket. The insertion pocket can be located on the side of the storage pocket 40 facing toward or also facing away from the operating unit 10.

According to the illustration according to FIG. 5, the operating unit 10 and the power supply unit 33 or the operating unit 10 and the inductor 35 are spatially separated from one another, because the operating unit 10 is not inserted into the storage pocket 40 for reasons of simplified illustration. However, if the operating unit 10 is inserted into the storage pocket 40, the inductors 21 and 35 of the operating unit 10 and the energy transmission unit 30, respectively, are arranged close to one another. In addition, a fixing aid can be provided in the storage pocket 40 for positioning the operating unit 10 in the storage pocket 40.

The line 41 is used for transmitting electrical energy from the power supply unit 33 to the storage pocket 40. Alternatively, the line 41 is designed both for transmitting electrical energy and also for transmitting items of information, for example, items of information on the charge state of the electrical energy accumulator 17. Partial components such as the DC/AC converter 34 or the control apparatus 37 are then arranged in the housing 31 of the power supply unit 33.

The storage pocket 40 in the exemplary embodiment of FIG. 5 furthermore also has an option for attachment to a piece of furniture 1 or to another object. Such options for attachment can be formed by adhesive strips or adhesive pads or by hooks or by screws or by installation supports. The convenience for the user is therefore advantageously significantly increased when a wireless operating unit 10 is always close to hand at the item of furniture.

Alternatively, a storage shell can be integrated as a type of molded nest into the item of furniture 1 itself or inserted into a furniture component. In both embodiments, it is advantageous that the operating unit 10 experiences, due to a suitable fixing means in the form of holding or guiding webs or in the form of cell or in the form of a geometric contour or in the form of at least one permanent magnet, an alignment and/or positioning upon placement on the transmission unit 33, by which the inductors 21, 35 of operating unit 10 and transmission unit 33 are moved into direct proximity to one another, so that energy can be transmitted optimally and with low loss.

The mentioned storage shell is considered to be equivalent to the storage pocket 40 with respect to its technical function. A storage shell is distinguished in that the operating unit 10 is inserted into a cell-shaped or trough-shaped contour. In contrast, a storage pocket 40 is distinguished in that it at least partially also encloses the operating unit 10 after the insertion.

### LIST OF REFERENCE NUMERALS

1 item of furniture
2 base element
3 support element
4 back part
5 leg part
6 movement fitting
7, 8 adjusting drives
9 control device
91 control unit
92 adjusting drive terminal
93 receiver
94 power supply unit
95 network terminal
96 network cable
97 low voltage output
98 network cutoff device
99 network cutoff control terminal
M mattress
10 operating unit
11 housing
12, 13 operating element
14 signaling element
15 control unit
16 transmission unit
17 electrical energy accumulator
20 device for receiving inductively transmitted energy
21 inductor (receiving coil)
22 AC/DC converter
30 energy transmission unit
31 housing
32 power supply terminal
33 power supply unit
34 DC/AC converter
35 inductor (transmitting coil)
36 network cable
37 control apparatus
38 control terminal
40 storage pocket
41 line

1.-18. (canceled)

19. An operating unit for an electromotive adjusting drive of an item of furniture, said operating unit comprising:
an operating element;
a transmission unit configured to wirelessly transmit a signal in response to an actuation of the operating element;
a rechargeable energy accumulator configured to store electrical energy for a power supply of the operating unit; and
a device configured to inductively receive energy for charging the energy accumulator.

20. The operating unit of claim 19, wherein the device includes an inductor for receiving the energy and an AC/DC converter connected to the inductor.

21. The operating unit of claim 20, further comprising a housing, said inductor being formed as a coil having a ferrite core, said coil being arranged inside the housing adjacent to a wall of the housing.

22. The operating unit of claim 20, wherein the AC/DC converter is connected to a charging circuit for the energy accumulator.

23. The operating unit of claim 19, wherein the energy accumulator is a rechargeable battery or a high-capacitance capacitor.

24. The operating unit of claim 19, wherein the device includes a data transmission unit for inductive transmission of data.

25. The operating unit of claim 24, wherein the data transmission unit is connected to a charge state monitor to monitor a charge state of the energy accumulator.

26. A control system for controlling an adjusting drive of an item of furniture, said control system comprising:
an operating unit including an operating element, a transmission unit configured to wirelessly transmit a signal in response to an actuation of the operating element, a rechargeable energy accumulator configured to store electrical energy for a power supply of the operating unit, and a device configured to inductively receive energy for charging the energy accumulator;
a control device connected to the adjusting drive, said control device being configured to receive a wirelessly transmitted signal of the operating unit and to control the adjusting drive as a function of the received signal; and
an energy transmission unit configured to inductively transmit electrical energy to the operating unit.

27. The control system of claim 26, wherein the energy transmission unit is connected to the control device or is integrated into the control device for power supply of the energy transmission unit.

28. The control system of claim 26, wherein the energy transmission unit includes a power supply unit which is separate from the control device.

29. The control system of claim 26, wherein the control device has a network cutoff device, which is coupled to the energy transmission unit such that a network cutoff occurs when the operating unit interacts with the energy transmission unit.

30. The control system of claim 26, wherein the energy transmission unit is configured to activate a network cutoff when the operating unit inductively receives energy from the energy transmission unit.

31. The control system of claim 26, wherein the energy transmission unit includes a data transmission unit for inductive transmission of data.

32. The control system of claim 26, wherein the energy transmission unit is configured to set a maximum transmitted power as a function of data received by the data transmission unit.

33. The control system of claim 32, wherein the data relate to a charge state of the energy accumulator of the operating unit.

34. An item of furniture, comprising:
an adjusting drive;
a base element;
a support element movably guided in the base element by the adjusting drive; and
a control system configured to control the adjusting drive, said control system comprising an operating unit including an operating element, a transmission unit configured to wirelessly transmit a signal in response to an actuation of the operating element, a rechargeable energy accumulator configured to store electrical energy for a power supply of the operating unit, and a device configured to inductively receive energy for charging the energy accumulator, a control device connected to the adjusting drive, said control device being configured to receive a wirelessly transmitted signal of the operating unit and to control the adjusting drive as a function of the received signal, and an energy transmission unit configured to inductively transmit electrical energy to the operating unit.

35. The item of furniture of claim 34, wherein the energy transmission unit of the control system is entirely or partially integrated into the item of furniture.

36. The item of furniture of claim 34, wherein the operating unit includes an inductor, said energy transmission unit including a storage option for the operating unit, with the storage option and the inductor being integrated into the item of furniture.
